(19) United States
(12) Patent Application Publication
(10) Pub. No.: US 2010/0156755 A1
(43) Pub. Date: Jun. 24, 2010

(54) Display Panel Control Device

(76) Inventor: Ching-Pao Chou, Taipei (TW)

Correspondence Address: Troxell Law Office Pllc, 4338 Old Columbia Pike, Annandale, VA, 22003, US

(21) Appl. No.: 12/407,517

(22) Filed: Mar. 19, 2009

(30) Foreign Application Priority Data
Dec. 19, 2008 (TW) 097149867

(51) Int. Cl. G09G 5/00; G08B 21/00

(52) U.S. Cl. 345/1.1; 340/540

(57) ABSTRACT

A display panel control device includes display panels, light sensors and control units. The display panels contain respectively plural illuminating elements to function for illumination. A quantity of the light sensor is equivalent to that of the display panel that each display panel includes one light sensor. A quantity of the control unit is equivalent to that of the display panel that each display panel includes one control unit. The control unit in each display panel is electrically connected with the light sensor, and is also electrically connected with each other. Therefore, the display panels can support one another to automatically fetch and adjust output power ratio of the illuminating elements in each display panel, each display panel can feed back a malfunctioning message of the light sensor, the output power ratio of each illuminating element of each display panel can be controlled actively, and maintenance can be facilitated.

### BACKGROUND OF THE INVENTION

a) Field of the Invention

The present invention relates to a display panel control device, and more particularly to an assembly design of more than one display panel, more than one light sensor and more than one control unit, providing effects that the display panels can support mutually or one another to fetch automatically an illuminating ratio of each illuminating element, each display panel can feed back a malfunction message of the light sensor, the illuminating ratio of each illuminating element of each display panel can be controlled actively, and maintenance can be facilitated, thereby being applied to all kinds of display panel control devices or other similar devices.

b) Description of the Prior Art

A conventional display panel (can be a single-sided or a double-sided display panel) is used primarily in displaying information of traffic conditions or places of athletic games, and is constituted by an LED (Light Emitting Diode) display unit, a light sensor and a control unit. The light sensor (e.g., a photo-resistor) is used to detect brightness of ambient environment. When a brightness detection value (e.g., photo-resistance) of the ambient environment is produced and transmitted to the control unit, the control unit will determine an illuminating ratio of the LED display unit based on this data. However, if there is an abrupt weather change, impact by external force or other causes that makes the light sensor malfunctioning (power required for illuminating is not interrupted), then the detection value of the brightness of the ambient environment will be kept by the value prior to the malfunctioning and cannot be used to adjust automatically the illuminating ratio of the LED display unit depending upon a change of the brightness of the ambient environment. Therefore, the display panel will be too bright or too dark to carry out its normal functions, which is still unable to fit the real needs in practical application.

### SUMMARY OF THE INVENTION

The primary object of the present invention is to provide a display panel control device, wherein more than one display panel is provided with plural illuminating elements, a control unit is electrically connected with a light sensor in each display panels and the control unit in each display panel is also electrically connected with each other, such that when some light sensor is malfunctioning, the display panels can still support mutually or one another to automatically fetch and adjust an illuminating ratio of the illuminating element in each display panel, thereby improving functions of the entire device.

Another object of the present invention is to provide a display panel control device that by the electric connection between the control units configured upon each display panel and a connection to a central controller of a control center, each display panel can feed back a malfunctioning message of the light sensor and the illuminating ratio of each illuminating element upon each display panel can be controlled actively, thereby enhancing practicability of the entire device.

Still another object of the present invention is to provide a display panel control device that by further connecting a buzzer or a warning light (or both) to each display panel to show the warning message of malfunction, trouble-shooting can be facilitated, thereby increasing convenience of the operation and maintenance.

Accordingly, the present invention is a display panel control device, which includes more than one display panel, more than one light sensor and more than one control unit, wherein a plurality of illuminating elements are configured onboard the display panel, the corresponding amount of light sensor and control unit are installed within each display panel, a control unit is electrically connected with a light sensor in each display panel, and the control unit in each display panel is also electrically connected with each other, such that each display panel can support each other to automatically fetch and adjust the output ratio of each illuminating element on the display panel, the malfunctioning message of the light sensor can be fed back, the output power ratio of each illuminating element on each display panel can be controlled actively, and the operation and/or maintenance can be facilitated easily.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a local three-dimensional view of the present invention.

FIG. 2 shows a local three-dimensional view of the present invention at another view angle.

FIG. 3 shows a cutaway view of the present invention.

FIG. 4 shows a schematic view of a configuration that the present invention is connected to a central controller.

FIG. 5 shows another schematic view of a configuration of the present invention.

### DETAILED DESCRIPTION OF THE PREFERRED EMBODIMENTS

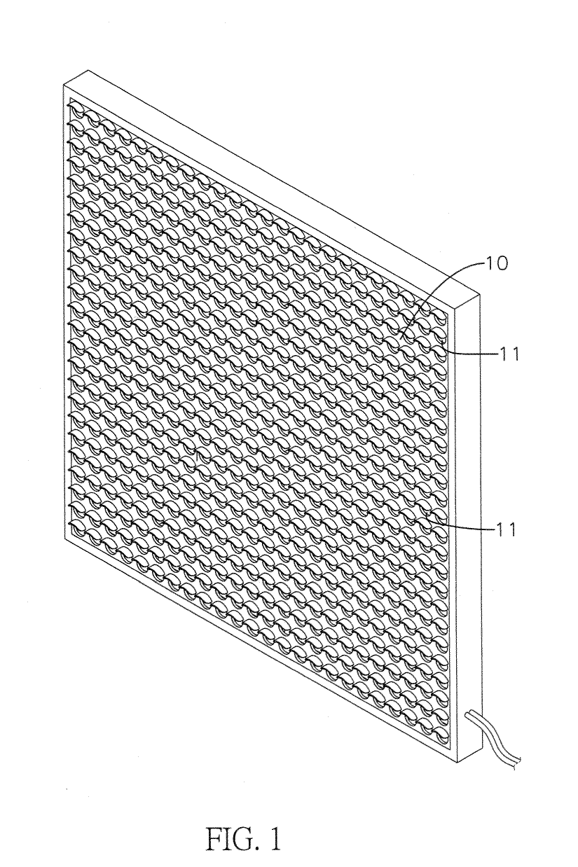

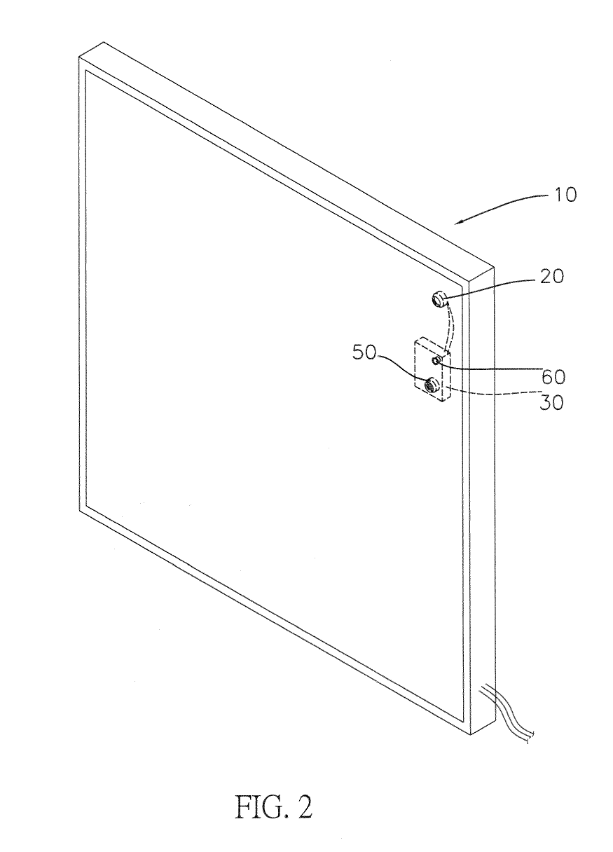

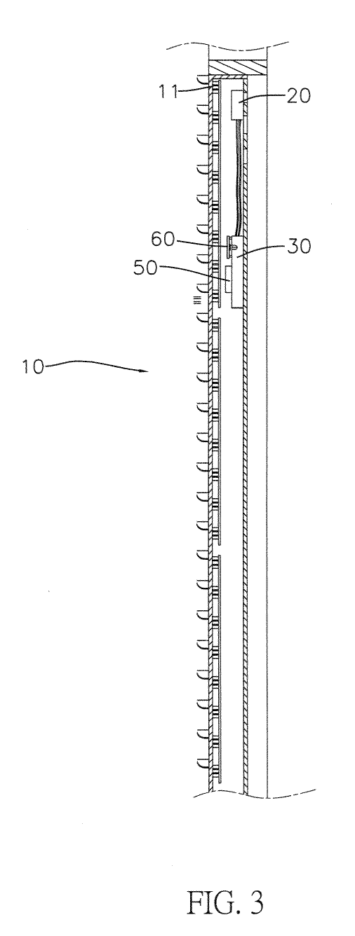

Referring to FIGS. 1 to 5, the present invention is a display panel control device comprising more than one display panel 10 which is provided respectively with plural illuminating elements 11 (e.g.: an LED, a lamp bulb, etc) to function for displaying; more than one light sensor 20 (e.g.: a photo-resistor, etc.) with a quantity corresponding to that of the display panel 10 to detect brightness of ambient environment and produce a detection value of brightness arising from the ambient environment; and more than one control unit 30, whose quantity is equivalent to that of the display panel 10 and each display panel 10 is provided respectively with one control unit 30. The control unit 30 in each display panel 10 is electrically connected with the light sensor 20, and the control unit 30 of each display panel 10 is also electrically connected with each other, thereby automatically fetching and adjusting an output power ratio of each illuminating element 11 in the display panel 10.

In addition, as the control unit 30 of each display panel 10 is electrically connected with each other, a central controller 40 of a control center can be further connected alternatively, such that each display panel 10 can feed back a malfunctioning message of the light sensor 20 and the output power ratio of each illuminating element 11 upon each display panel 10 can be controlled. Furthermore, each control unit 30 can be provided with a buzzer 50 or a warning light 60 (or both), to alert the malfunctioning message and/or status.

By the aforementioned description, a display panel control device is configured Referring to FIGS. 1 to 5, the features of the present invention lie in that the display panel control device can be assembled by more than one display panel 10, more than one light sensor 20 and more than one control unit 30; whereas, by that the plural illuminating elements 11 are provided respectively on more than one display panel 10, the illumination for display can be provided. On the other hand, the control unit 30 in each display panel 10 is electrically connected with the light sensor 20, and the control unit 30 of each display panel 10 is electrically connected with each other; therefore, when the light sensor 20 in some display panel 10 is malfunctioning, a neighboring display panel 10 can be fetched automatically and the output power of each illuminating element 11 on the malfunctioned display panel 10 can be adjusted accordingly, thereby increasing an entire function of the display panel 10. Moreover, by that the control unit 30 of each display panel 10 is electrically connected with each other and is connected to the central controller 40 of the control center, each display panel 10 can feed back the malfunctioning message of the light sensor 20 and the output power ratio of each illuminating element 11 of each display panel 10 can be controlled actively, thereby enhancing entire practicability and convenience of application. In addition, by that each control unit 30 can be further configured with a buzzer 50 or a warning light 60, the alerting of malfunctioning can be provided, thereby easily facilitating maintenance and trouble-shooting. Accordingly, the present invention is provided with the effects that the display panels 10 can support one another to automatically fetch the reference output power ratio from those normal display panels 10 and then the output power ratio of each illuminating element 11 on the malfunctioned display panels 10 can be adjusted, each display panel 10 can feed back the malfunctioning message of the light sensor 20, the illuminating ratio can be controlled actively, and the maintenance and trouble-shooting can be facilitated easily, thereby increasing the practicability and the convenience.

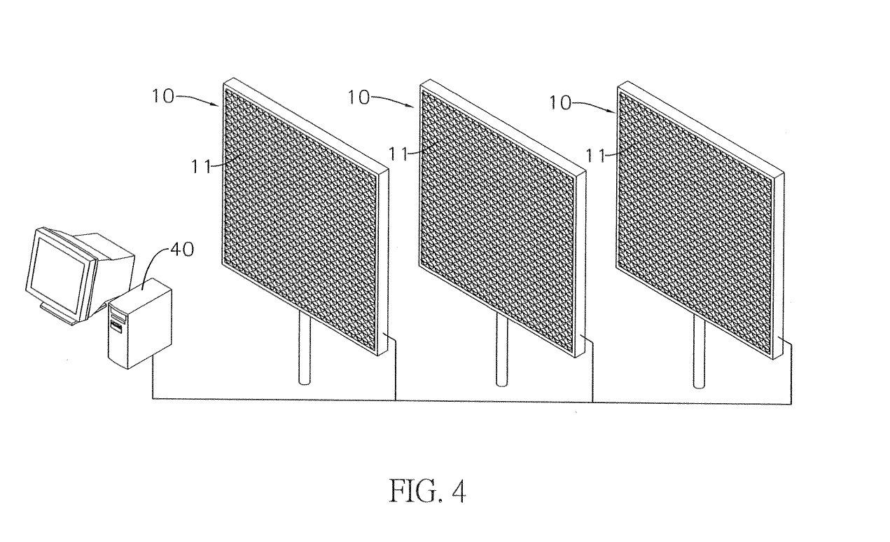

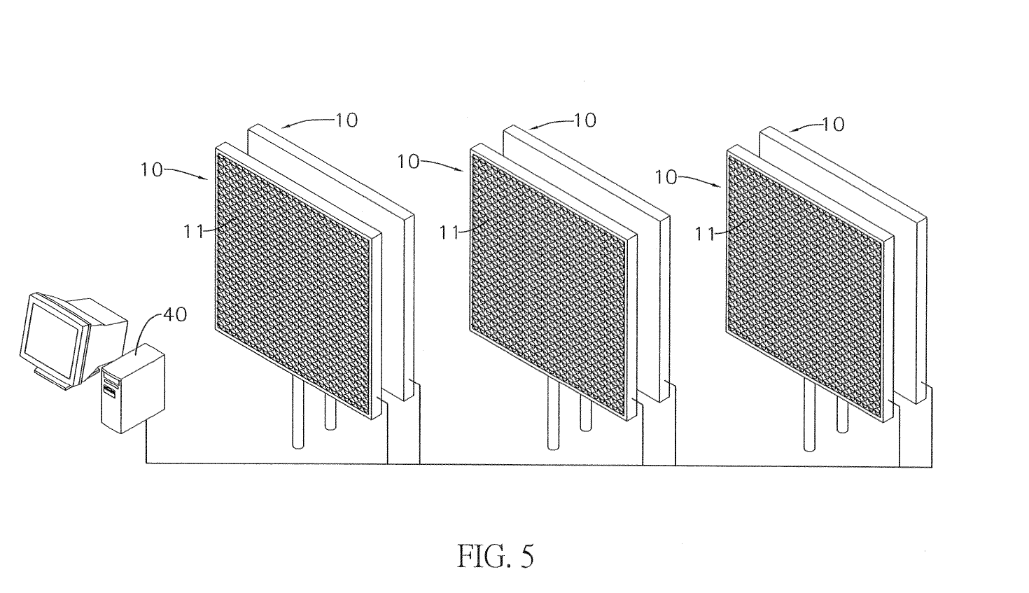

Referring to FIGS. 1 to 5, when the present invention is used practically, the control unit 30 of each display panel 10 can be pre-programmed with a reference mode of a value of brightness detected from the ambient environment, depending upon the place where the display panel control device (a single-sided or double-sided display panel, as shown in FIG. 4 and FIG. 5) is applied, and external weather. When some light sensor 20 is malfunctioning (for example, the detection value of brightness arising from the ambient environment has been fixed at a constant value for a certain period of time without change), the control unit 30 of that display panel 10 can select to take one of the following modes, according to the aforementioned pre-programmed reference mode:
1. Single reference: A brightness detection value of the light sensor on other specific display panel is adopted as a reference of output power ratio to drive each illuminating element on the malfunctioned display panel. This mode will usually select a specified neighboring display panel; however, if the neighboring display panel is also malfunctioning, then a next display panel and so forth will be adopted as the reference alternatively.
2. Group reference: Plural pre-set display panels at nearby locations are selected, and an averaged value or other computed algorithm of the brightness detection value of those light sensors of the display panels will be adopted as a reference of output power ratio to drive each illuminating element on the malfunctioned display panel. If some display panels among the plural display panels at the specific locations are also malfunctioning, then these malfunctioned display panels will be excluded in serving as the reference of the brightness.
3. Overall reference: An averaged value or other computed algorithm of the brightness of the light sensors of all the display panels will be used as a reference of output power ratio to drive each illuminating element on the malfunctioned display panel. Similarly, if some display panels among all the display panels are also malfunctioning, then these malfunctioned display panels will be excluded in serving as the reference of the brightness.

On the other hand, each display panel is provided with an identification code. If the central controller of the control center is connected selectively, then these identification codes can be added into the malfunctioning message of the light sensor. Besides, the malfunctioned display panel can produce warning sound or a light signal (by means of buzzer and/or warning light), allowing a technician to quickly locate the malfunctioned display panel in a regular maintenance or a trouble-shooting. Furthermore, the malfunctioned display panel can also feed back the identification code to inform the central controller of the control center a current working status of the display panels allowing the central controller of the control center to actively control the output power ratio of each illuminating element on that display panel.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A display panel control device comprising more than one display panel on which is provided respectively with plural illuminating elements to illuminate for display; more than one light sensor, a quantity of which is equivalent to that of the display panel that an interior of each display panel is provided respectively with one light sensor; and more than one control unit, a quantity of which is equivalent to that of the display panel that an interior of each display panel is provided respectively with one control unit; the control unit in each display panel being electrically connected with the light sensor, and the control unit in each display panel being electrically connected with each other, such that the display panels support mutually or one another to automatically fetch the reference output power ratio by different mode of algorithm and thus each illuminating element on the malfunctioned display panel is adjusted and controlled.

2. The display panel control device according to claim 1, wherein the mode of algorithm is a single reference.

3. The display panel control device according to claim 1, wherein the mode of algorithm is a group reference.

4. The display panel control device according to claim 1, wherein the mode of algorithm is an overall reference.

5. The display panel control device according to claim 1, wherein the illuminating element is a light emitting diode.

6. The display panel control device according to claim 1, wherein the illuminating element is a bulb.

7. The display panel control device according to claim 1, wherein the light sensor is a photo-resistor.

8. The display panel control device according to claim 1, wherein the control unit of each display panel is electrically connected with each other, and is selectively connected to a central controller of a control center which provides each display panel to feed back a malfunctioning message of the light sensor and actively controls the output power ratio of the plural illuminating elements of each display panel.

9. The display panel control device according to claim 1, wherein the control unit of each display panel is configured with a buzzer to indicate the malfunctioned display panel.

10. The display panel control device according to claim 1, wherein the control unit of each display panel is configured with a warning light to indicate the malfunctioned display panel.

11. The display panel control device according to claim 1, wherein the control unit of each display panel is configured both with a buzzer and a warning light to indicate the malfunctioned display panel.
